(19) United States
(12) Patent Application Publication
(10) Pub. No.: US 2023/0132178 A1
(43) Pub. Date: Apr. 27, 2023

(54) STATE MONITORING SYSTEM HAVING A BORESCOPE DEVICE FOR A GAS TURBINE

(71) Applicant: MTU Aero Engines AG, München (DE)

(72) Inventor: Bernd Kriegl, München (DE)

(73) Assignee: MTU Aero Engines AG, München (DE)

(21) Appl. No.: 17/785,334

(22) PCT Filed: Dec. 8, 2020
(86) PCT No.: PCT/DE2020/000325

§ 371 Date: Dec. 11, 2022

(30) Foreign Application Priority Data
Dec. 18, 2019 (DE) 10 2019 220 021.4

(51) Int. Cl. F01D 21/00; G01M 15/14; G02B 23/24

(52) U.S. Cl. CPC F01D 21/003; G01M 15/14; G02B 23/2492; G02B 23/2484; F05D 2260/83; F05D 2270/8041

(57) ABSTRACT

The invention relates to a monitoring system for a gas turbine, in particular for an aircraft engine. The monitoring system comprises at least one borescope device that is able to be mounted in a borescope opening of a gas turbine housing and has a housing, in which at least one optical sensor device for acquiring images of at least one inner region of the gas turbine is arranged, and an evaluation device that is able to be connected to the at least one borescope device in order to exchange data and is designed to inspect the at least one inner region for the presence of a fault on the basis of the at least one image acquired by way of the sensor device. The invention furthermore relates to a borescope device to an evaluation device and to a gas turbine.

### BACKGROUND OF THE INVENTION

The invention relates to a monitoring system for a gas turbine, a borescope device, and an evaluation device for such a monitoring system, as well as a gas turbine having such a monitoring system.

During operation, gas turbines are usually subject to high loads. For example, in the case of gas turbines designed as aircraft engines, various undesired events can occur during flight operation, such as, for example, a bird strike, a surge, temporary strong vibrations, hard landings, so-called “own object damages”, and the like, which necessitate a visual inspection of the inner region of the gas turbine. Usually in such inspections, at least the rotating blades in the compressor stage and/or turbine stage must be evaluated. These kinds of inspections in aircraft engines are presently carried out “on wing”, i.e., in the mounted engine, by video inspection. Correspondingly, in the case of stationary gas turbines, an inspection is also usually conducted directly at the site where the gas turbine is mounted. The disadvantage of these inspections consists in the circumstance that they are very time-consuming and require specially trained personnel, which is associated with a correspondingly large time commitment and high costs. So-called ETM data (engine trend monitoring data) in fact sometimes helps to detect a change in the gas turbine performance after these kinds of events; however, local damage may occur on individual blades or in the gas turbine housing, which does not as yet bring about a change in engine parameters or gas turbine performance, but is nevertheless critical. Therefore, at the present time, expensive video inspection after such events cannot be dispensed with.

### SUMMARY OF THE INVENTION

The object of the present invention is to make possible an improved monitoring of gas turbines and to provide a gas turbine having an improved monitoring system.

The objects according to the invention are achieved by a monitoring system for a gas turbine, by a borescope device, and an evaluation device for such a monitoring system, as well as by a gas turbine having this kind of monitoring system, each of the foregoing in accordance with the present invention.

Advantageous embodiments with appropriate enhancements of the invention are discussed in detail below, wherein advantageous embodiments of each aspect of the invention are to be viewed as advantageous embodiments of each of the other aspects of the invention.

A first aspect of the invention relates to a monitoring system for a gas turbine, in particular for an aircraft engine, comprising at least one borescope device that is able to be mounted in a borescope opening of a gas turbine housing and has a housing, in which at least one optical sensor device for acquiring images of at least one inner region of the gas turbine is arranged, and an evaluation device that is able to be coupled to the at least one borescope device in order to exchange data and is designed to inspect the at least one inner region for the presence of a fault on the basis of the at least one image acquired by way of the sensor device. The monitoring system according to the invention thus makes possible an automatic or at least predominantly automated inspection of all sensitive regions in the gas turbine, for example of compressor and/or turbine stages, rotating blades, guide vanes, or housing parts. In this case, the inspection by the monitoring system generally can be carried out after particular events or regularly, for example during the shutdown process of the gas turbine. In this case, the inspection for the presence of one or more faults can be conducted on the basis of the acquired image or acquired images and/or videos. Depending on the inspection result, a direct feedback response can then be made by the evaluation device that, and optionally where, damage might be present, and/or whether, and optionally where, a more comprehensive automatic and/or manual inspection is necessary. The monitoring system according to the invention (“On Board Failure Detection and Warning System”) can accordingly be selectively installed temporarily for one or more inspections or permanently for continuous or regular inspections of the gas turbine. The inspection can take place, for example, during the shutdown process of the gas turbine in a defined speed range of the rotor by acquiring one or more images of critical inner spatial regions and evaluating these for the presence of faults. In general, the evaluation device can also be installed directly or indirectly on the gas turbine. Alternatively, the evaluation device can be installed independently from the gas turbine and the inspection for faults can be carried out only after coupling to the at least one borescope device and/or after the transmission of the one or more acquired images. Advantageously, the monitoring system can also be retrofitted for existing gas turbines. At the present time, for this purpose, conventional sealing plugs (so-called “borescope plugs”) of borescope openings or channels with the usual diameters of 6, 8 or 10 mm can be used for mounting the correspondingly fitted borescope device. Basically, any suitable camera system can be used as the optical sensor device, wherein the camera system is preferably designed without fiber-optic elements or light guides. In general, “a/an” is to be read as the indefinite article in the scope of this disclosure, and thus unless there is an indication to the contrary, is also always read as “at least one”. Conversely, “a/an” can also be understood as “only one”. In general, it is also noted that the terms “axial” or “axially,” “radial” or “radially” and “peripheral” always refer to the machine axis or axis of rotation of the gas turbine, insofar as something else is not indicated implicitly or explicitly from the context.

In an advantageous embodiment of the invention, it is provided that the borescope device has a thread, by which the borescope device can be mounted in a counter-thread of the gas turbine housing. A simple and basically demountable mounting of the borescope device on the gas turbine housing is thereby made possible, so that selectively, a temporary or a permanent installation on the gas turbine housing can be carried out in a particularly simple manner. Alternatively or additionally, it is provided that the borescope device and/or the gas turbine housing has a sealing device, which, when the borescope device is in the mounted state, the gas turbine housing is sealed with respect to the surroundings, and/or by which the borescope opening is tightly sealed in the mounted state. Preferably, the sealing device can have at least one sealing element, in particular a sealing ring. A gas-tight connection can be obtained thereby and an undesired drop in pressure in the gas turbine can be avoided, so that the borescope device can remain mounted in a particularly disturbance-free manner also during the operation of the gas turbine. According to another preferred embodiment of the invention, the thread and/or the sealing device of the borescope device is/are fitted and set up in such a way that the borescope opening is also sealed during the operation of the gas turbine, i.e., it is sealed without significant pressure losses. During the operation of a gas turbine, very high pressures occur and the pressure ratios act directly on the performance of the gas turbine. Since the borescope device is provided for the purpose of also remaining mounted on the gas turbine during operation, it is of great advantage if the borescope device and the borescope opening are designed and fitted together in such a way that no essential drop in pressure occurs at the borescope opening that is sealed by the borescope device.

According to a preferred embodiment of the invention, the borescope device has an on-board power supply. For this purpose, the borescope device can be connected or is connectable, for example, to the on-board network of an aircraft, or can have its own power supply (e.g., battery/rechargeable battery/capacitor) for the supply of electrical power. Due to the fact that the borescope device is supplied with electrical power either in a self-sufficient manner or by the aircraft on which the gas turbine is installed, for example, on-wing investigations can be carried out by remote diagnostics, without the need for maintenance personnel to first install a borescope on the gas turbine for this purpose.

In another advantageous embodiment of the invention, it is provided that the borescope device comprises at least one light source, by which the inner region of the gas turbine is illuminated. Advantageous lighting conditions can be assured in this way for the acquisition of the one or more images of the inner region of the gas turbine that are being monitored, whereby a correspondingly improved fault inspection can be achieved.

Further advantages result in that the borescope device comprises at least one cooling channel, through which a cooling medium can be guided at least for cooling the at least one sensor device. The borescope device can also be reliably operated thereby under higher ambient and/or gas temperatures, and the at least one sensor device will be protected from overheating. For example, engine cooling air which is usually present without anything further can be used as cooling medium. For this purpose, the cooling channel can have a corresponding inlet and outlet for the engine cooling air or be fluidically coupled with such inlet and outlet. Alternatively or additionally, the borescope device can be supplied with its own fluidic or gaseous cooling medium that can be guided within a circuit.

Additional advantages result from the fact that an end region of the housing that is on the side of the gas channel has a geometry that is adapted to a predetermined installation site of the borescope device on the housing of the gas turbine, and in the mounted state of the borescope device, assures a predetermined orientation at least of the at least one sensor device inside the gas turbine housing. In this way, an optimal alignment and positioning of the sensor device and optionally of an also present light source is reliably assured, so that time-consuming adjustment operations during the mounting can be dispensed with. Such a level-specific design with defined insertion position and installation of the borescope device (smart plug) always assures a correct orientation of the camera(s) onto the desired regions (e.g., blade tips, leading and trailing edges of blades, housing parts, etc.) of the elements of the gas turbine lying upstream or downstream. Alternatively or additionally, it is provided that the end region of the housing on the side of the gas channel has an aerodynamically adapted geometry relative to the predetermined insertion site of the borescope device on the gas turbine housing. An acquisition of images without disrupting the flow in the gas channel of the gas turbine housing is made possible in this way. Alternatively or additionally, the end region of the housing on the side of the gas channel is provided with a protective glass that is particularly resistant to high temperatures. This represents a structurally simple possibility for protecting the sensor device and optionally present light sources from the operating fluid of the gas turbine without adversely affecting the image capture and optionally the illumination of the inner region being inspected.

In another advantageous embodiment of the invention, it is provided that the borescope device can be coupled with the evaluation device via a detachable plug connection for exchange of data, and/or can be coupled with an electrical energy source for power supply. A simple, flexible and operationally reliable coupling is made possible thereby for exchange of data, i.e., for example, for transmission of image and/or control data, and/or for the power supply of the sensor device and optionally of the light source.

In another advantageous embodiment, it is provided that the evaluation device is designed for the purpose of being coupled with a plurality of borescope devices for the exchange of data and, on the basis of the respectively acquired images, for inspecting whether a fault is present in a respectively assigned inner region of the gas turbine housing. In other words, a single evaluation device can receive and evaluate the image data of a plurality of borescope devices. Various advantages are attained thereby, such as, for example, a reduction in weight, a simpler mounting and demounting of the monitoring system, as well as reduced complexity and reduced fault sensitivity.

Additional advantages result due to the fact that the evaluation device is designed for the purpose of carrying out an inspection of the at least one inner space, depending on the rotor speed of the gas turbine, in particular a rotor speed of at most 20 rpm, and/or depending on an operational state of the gas turbine. In this way, it is possible to carry out an automatic or automated inspection of all sensitive stages/airfoils/housing regions in the gas turbine either after particular events or regularly, for example, during the shutdown process of the gas turbine or during idling. Alternatively or additionally, it is provided that the evaluation device is designed for the purpose of carrying out an on-board inspection and/or an off-board inspection of the acquired images. In other words, depending on the embodiment of the monitoring system each time, the analysis can take place either on-board and without disassembly or removal of the gas turbine from its place of use, or can be carried out also in an off-board manner after transmission of the captured image data to an external evaluation device (data processing & analysis unit) not connected to the turbomachine or mounted on the turbomachine. This permits a particularly high flexibility in the design and arrangement of the monitoring system, so that existing gas turbines and turbomachines can also be retrofitted in a particularly simple manner.

Further advantages result from the fact that the evaluation device comprises a memory unit for storing the acquired images and/or an inspection result, and/or that the evaluation device is designed for the purpose of comparing at least one acquired image with at least one stored image during the inspection, and/or that the evaluation device is designed for the purpose of considering at least one historical inspection result during the inspection, and/or that the evaluation device is designed to be self-learning. Advantageously, the quality of the inspection can be increased in this way.

In another advantageous embodiment of the invention, it is provided that the evaluation device is designed for the purpose of creating a report of the results of the inspection and/or of releasing a warning if a fault has been identified during the inspection, and/or of producing an “all clear” if a fault has not been identified during the inspection, and/or of providing information on the type and/or site of a fault that was identified during the inspection, and/or of prompting a maintenance of the gas turbine if a fault has been identified during the inspection. In this way, the operator of the monitoring system receives a feedback response on the state of the gas turbine and optionally can carry out or prompt further steps, such as, e.g., a manual inspection, a maintenance plan, and the like.

A second aspect of the invention relates to a borescope device for a monitoring system according to the first aspect of the invention, wherein the borescope device can be mounted in a borescope opening of a gas turbine housing of a gas turbine and has a housing, in which at least one optical sensor device for acquiring images of at least one inner region of the gas turbine is arranged, wherein the borescope device for exchange of data can be coupled to at least one evaluation device of the monitoring system. The borescope device according to the invention, which can also be called a “smart plug”, can therefore be incorporated temporarily or permanently at the site of the currently common sealing plugs (borescope plugs) in the compressor and/or turbine region of a turbomachine. The end of the borescope device on the side of the gas channel contains a plurality of sensor devices (e.g., cameras) and optionally one or more light sources, each time depending on the space available (usual diameter of 6, 8 or 10 mm). In this way, a level-specific design of the borescope device with defined insertion position and installation can be provided, whereby a correct orientation of the camera(s) onto the one or more desired regions (e.g., blade tips, leading and trailing edges) of the housing structures lying upstream or downstream (e.g., compressor or turbine blades) is always assured. The power supply and/or the exchange of data are preferably carried out over integrated lines in the borescope device, wherein one or a plurality of plug connections can be provided at the end away from the flow channel in certain embodiments. Preferably, the borescope device is fastened in or on the compressor or turbine housing of the gas turbine by screwing into a corresponding borescope opening. Additional features and the advantages thereof can be derived from the descriptions of the first aspect of the invention.

A third aspect of the invention relates to an evaluation device for a monitoring system according to the first aspect of the invention, which evaluation device can be coupled for exchange of data to at least one borescope device according to the second aspect of the invention and is designed for the purpose of inspecting the at least one inner region of the gas turbine housing for the presence of a fault on the basis of the at least one image acquired by way of the sensor device. This permits a correspondingly rapid, simple, and automated or able to be automated inspection of the gas turbine or turbomachine for the presence of possible problems. Preferably, the evaluation device has integrated image processing software or hardware that is able to assign multiple recordings, via component markings or image features that are present, to the same turbomachine structure, e.g., to the same blade, in order to assure a clear identification. The evaluation device is preferably designed as self-learning, or results from earlier inspections are stored in memory and used for current inspections. In general, the inspection can take place either on-board or off-board, after transmission of the image data of the borescope device(s), or in an external evaluation device. Additional features and the advantages thereof can be derived from the descriptions of the first and second aspects of the invention.

A fourth aspect of the invention relates to a gas turbine, in particular an aircraft engine, comprising a gas turbine housing having at least one borescope opening, wherein, according to the invention, at least one monitoring system according to the first aspect of the invention is provided, wherein at least one borescope device of the monitoring system is mounted in the borescope opening and is coupled with an evaluation device of the monitoring system. The features resulting therefrom and the advantages thereof can be taken from the descriptions of the first, second, and third aspects of the invention.

In an advantageous embodiment of the invention, it is provided that the at least one borescope device is mounted, preferably permanently, in the region of a compressor stage and/or in the region of a turbine stage of the gas turbine. This makes possible an optionally regular automatic inspection of the gas turbine for possible problems.

Further advantages result from the fact that the at least one borescope device is mounted in the region of a guide vane ring and/or that the at least one sensor device of the borescope device is aligned for acquiring images of a predetermined rotating blade region, in particular for acquiring images of a blade tip region, a blade leading edge region, and/or a blade trailing edge region. In particular, rotating blades that usually have been particularly greatly affected by events such as a bird strike, a surge, temporarily high vibrations, hard landings, “own object damages” and the like can be regularly and reliably inspected so that in the case there is a fault, it can be immediately addressed.

### BRIEF DESCRIPTION OF THE DRAWING FIGURE

Additional features of the invention result from the claims, the figures, and the description of the figures. The features and combinations of features named above in the description, as well as the features and combinations of features named below in the description of the figures and/or in the figures shown alone can be used not only in the combination indicated in each case, but also in other combinations, without departing from the scope of the invention. Thus, embodiments that are not explicitly shown and explained in the figures, but proceed from the explained embodiments and can be produced by separate combination of features, are also to be viewed as comprised and disclosed by the invention. Embodiments and combination of features that thus do not have all features of an originally formulated independent claim are also to be viewed as disclosed. Moreover, embodiments and combination of features that depart from the combination of features presented in references back to the claims or deviate from these are to be viewed as disclosed particularly by the embodiments presented above.

Here, the single FIGURE shows a schematic excerpt of a gas turbine having a monitoring system according to the invention.

### DESCRIPTION OF THE INVENTION

The single figure shows a schematic excerpt of a gas turbine 10 having a monitoring system according to the invention 12. Of the gas turbine 10, only a part of a gas turbine housing 14 is illustrated, in which a rotor (not shown) having two rotating blade rings 16a, 16b and a guide vane ring 18 lying between them is arranged. In addition, exemplary run-in linings 20 for the rotating blade rings 16a, 16b are shown on the side of the housing. In the region of the guide vane ring 18 is found a borescope opening 22 with a counter thread 23, into which a borescope device according to the invention 24 is screwed for permanent assembly via a thread 25, instead of a sealing plug (borescope plug). The latter has a housing 26, in which at least one optical sensor device 28, for example a camera, for acquiring images of at least one inner region of the gas turbine housing 14 is arranged. In the mounted state, the housing 26 is sealed in a gas-tight manner relative to the gas turbine housing 14 by a sealing device 27 configured presently as an O-ring, so that the borescope device 24 can remain permanently inserted, thus also during the operation of the gas turbine 10. Additionally, in the example of embodiment shown, a basically optional light source 30 is also present, by which the trailing edges of the rotating blades of the rotating blade ring 16a are illuminated. The sensor device 28 is correspondingly aligned on the trailing edges of the rotating blades and comprises the field of view characterized by the reference character I. The geometry of the end of the borescope device 24 on the side of the gas channel is thereby preferably configured such that an optimal alignment and positioning of camera(s) 28 and light source(s) 30 are possible without influencing the flow in the gas channel. By a level-specific design with defined insertion position and installation of the borescope device 24 (smart plug), in corresponding embodiments, a correct orientation of the camera(s) 28 on the desired regions (e.g., blade tips, leading and trailing edges) of the blades lying upstream or downstream (compressor or turbine blades) is automatically assured. The power supply and the data exchange of the acquired images with an evaluation device 34 of the monitoring system 12 are carried out in the present example by way of lines integrated in the housing 26, as well as via a plug connection 32 with a connecting cable 36 on the screwing-in end of the borescope device 24. In an analogous way, additional borescope devices 24 can be connected to the evaluation device 34. Depending on the configuration of the guide vanes each time (distance, airfoil geometry, etc.), one or a plurality of borescope devices 24 can be incorporated between the guide vanes 18, in order to make possible the desired view to the structures lying upstream and downstream. For insertion positions with higher ambient or gas temperatures, the borescope device 24 can be cooled, for example, by the existing engine cooling air, in order to protect the camera(s) 28 and light source(s) 30. For this purpose, a cooling channel (not shown) can be provided in housing 26, through which a cooling medium can be guided. Embodiments with protective glass are also possible.

During each shutdown process of the gas turbine 10 or also selectively after particular events, the images of borescope device(s) 24 are characterized, for example, by speeds of <20 rpm. In general, in order to obtain an optimal data processability for the analysis with a sufficient image quality, the recording speed range per borescope device 24 or per insertion position can be adjusted individually. The integrated image processing software of the monitoring system 12 can therefore assign multiple recordings to the same blade or the same housing structure by way of component markings or image features that are present. The image analysis software of the evaluation device 34 preferably carries out a comparison with earlier image recordings, e.g., of the last shutdown process, reports at which sites changes are recognizable, and creates a report of results. Preferably, a manual inspection is recommended as soon as possible only in case of anomalies. It may be provided that the evaluation device 34 is designed as self-learning and results from historic inspections are stored in memory and considered correspondingly for the current inspection in the analysis software or in the evaluation algorithms. Depending on the installed system in each case, the analysis can take place either on-board or also can be carried out off-board after transmission of the image recordings to an external evaluation device 34.

The parameter values indicated in the documentation for the definition of process conditions and measurement conditions for characterizing specific features of the subject of the invention, even if found within the framework of deviations—for example, based on measurement errors, system errors, weighing errors, DIN tolerances and the like,—are to be viewed as encompassed by the scope of the invention.

1. A monitoring system for a gas turbine, comprising:
at least one borescope device mounted in a borescope opening of a gas turbine housing and has a housing in which at least one optical sensor device for acquiring images of at least one inner region of the gas turbine is arranged; and
an evaluation device that is coupled to the at least one borescope device to exchange data and is configured and arranged to inspect the at least one inner region for the presence of a fault on the basis of the at least one image acquired by way of the sensor device.

2. The monitoring system according to claim 1, wherein the borescope device has a thread, by which the borescope device is mounted on a counter-thread of the gas turbine housing and/or wherein the borescope device in the mounted state tightly seals the gas turbine housing by a sealing device.

3. The monitoring system according to claim 1, wherein the borescope device comprises at least one light source, by which the inner region of the gas turbine is illuminated.

4. The monitoring system according to claim 1, wherein the borescope device comprises at least one cooling channel, through which a cooling medium is guided.

5. The monitoring system according to claim 1, wherein an end region of the housing that is on a side of a gas channel has a geometry that is fitted to a predetermined installation site of the borescope device on the gas turbine housing, and in the mounted state of the borescope device, assures a predetermined orientation at least of the at least one sensor device inside the gas turbine housing, and/or wherein the end region of the housing on the side of the gas channel has an aerodynamically adapted geometry relative to the predetermined installation site of the borescope device on the gas turbine housing, and/or wherein the end region of the housing on the side of the gas channel is provided with a protective glass that is resistant to high temperatures.

6. The monitoring system according to claim 1, wherein the borescope device is coupled to the evaluation device via a detachable plug connection for exchange of data, and/or is coupled to an electrical energy source for power supply.

7. The monitoring system according to claim 1, wherein the evaluation device is coupled to a plurality of borescope devices for data exchange and of inspecting for the presence of a fault in a respectively assigned inner region of the gas turbine housing on the basis of the respective acquired images.

8. The monitoring system according to claim 1, wherein the evaluation device is configured and arranged for carrying out an inspection of the at least one inner space, as a function of a rotor speed of at most 20 rpm of the gas turbine and/or an operational state of the gas turbine, and/or wherein the evaluation device is configured and arranged for carrying out an on-board inspection and/or an off-board inspection of the acquired images.

9. The monitoring system according to claim 1, wherein the evaluation device comprises a memory unit for storing the acquired images and/or an inspection result, and/or wherein the evaluation device is configured and arranged for comparing at least one acquired image with at least one stored image during the inspection, and/or wherein the evaluation device is configured and arranged for considering at least one historical inspection result during the inspection, and/or wherein the evaluation device is configured and arranged to be self-learning.

10. The monitoring system according to claim 1, wherein the evaluation device is configured and arranged for:
creating a report on the results of the inspection; and/or
producing a warning if a fault has been identified during the inspection; and/or
producing an “all clear” if a fault has not been identified during the inspection; and/or
producing information on the a type and/or location of a fault identified during the inspection; and/or
prompting a maintenance of the gas turbine if an error has been identified during the inspection.

11. A borescope device for a monitoring system according to claim 1, wherein the borescope device is mounted in a borescope opening of a gas turbine housing of a gas turbine and has a housing, wherein at least one optical sensor device for acquiring images of at least one inner region of the gas turbine housing is arranged, wherein, for exchange of data, the borescope device is coupled to at least one evaluation device of the monitoring system.

12. An evaluation device for a monitoring system according to claim 1, being configured and arranged for inspecting the at least one inner region of the gas turbine housing for the presence of a fault on the basis of the at least one image acquired by way of the sensor device.

13. A gas turbine, comprising a gas turbine housing with at least one borescope opening, wherein at least one monitoring system according to claim 1 is provided, wherein at least one borescope device of the monitoring system is mounted in the borescope opening and is coupled to an evaluation device of the monitoring system.

14. The gas turbine according to claim 13, wherein the at least one borescope device is mounted, preferably permanently, in a region of a compressor stage and/or in a region of a turbine stage of the gas turbine.

15. The gas turbine according to claim 13, wherein the at least one borescope device is mounted in the region of a guide vane ring, and/or in that the at least one sensor device of the borescope device is aligned for acquiring images of a predetermined rotating blade region.

16. An evaluation device for a monitoring system, which, for data exchange, is connected to at least one borescope device according to claim 11, and is configured and arranged for inspecting the at least one inner region of the gas turbine housing for the presence of a fault on the basis of the at least one image acquired by way of the sensor device.

17. The monitoring system according to claim 1, wherein the gas turbine is an aircraft engine.

18. The gas turbine according to claim 14, wherein the at least one borescope device is mounted permanently.

19. The gas turbine according to claim 15, wherein the predetermined rotating blade region is a blade tip region, a blade leading edge region, and/or a blade trailing edge region.
